(19) United States
(12) Patent Application Publication
(10) Pub. No.: US 2008/0032191 A1
(43) Pub. Date: Feb. 7, 2008

(54) SYSTEMS AND METHODS FOR PORTABLE ELECTRICAL STORAGE

(76) Inventors: Gregory Kennedy, Moab, UT (US); Douglas Kennedy, Moab, UT (US)

Correspondence Address: BAKER & ASSOCIATES PLLC, 470 EAST NINTH AVENUE, SALT LAKE CITY, UT, 84103, US

(21) Appl. No.: 11/462,908

(22) Filed: Aug. 7, 2006

(51) Int. Cl. H01M 2/08; B65D 85/00

(52) U.S. Cl. 429/185; 29/623.2; 429/153; 206/704

(57) ABSTRACT

The present invention relates to a protected and portable battery storage system and method of use. One embodiment relates a portable battery storage system, including a plurality of batteries and a plurality of sealed pouches. The batteries are shaped in a coin or disc configuration. The sealed pouches are interconnected to one another in a strip configuration. The batteries are positioned within a non-conductive internal region of each sealed pouch that protects them from damage and incidental short-circuiting. The non-conductive internal regions of the sealed pouches are sealed air-tight from the exterior via a lamination closure. The sealed pouches further include an individual opening system to allow a user to open a single sealed pouch for removal of the corresponding battery. One particular opening system includes a notch to facilitate hand-tearing of the sealed pouch. An alternative opening system includes utilizing a resealable opening system such as a ZIPLOC closure. A second embodiment of the present invention relates to dimensionally reducing a battery storage system by rolling or folding a plurality of sealed pouches coupled together in a strip configuration.

### FIELD OF THE INVENTION

The invention generally relates to portable electrical storage systems. In particular, the present invention relates to a protected and portable battery storage system and method of use.

### BACKGROUND OF THE INVENTION

Portable electrical devices require a power source or power supply to provide the necessary electricity to operate. For example, flashlights commonly utilize one or more batteries to provide electricity to illuminate an LED or bulb. A battery is a common type of portable electric power source. Batteries are designed to provide a particular amperage and voltage for a particular duration or capacity. The size of a battery is directly proportional to the voltage, amperage, and capacity. Batteries are made in various form factors, output voltages, output amperages, and capacities. One of the problems with long-term portable electric device usage is the necessity to carry additional batteries. Since a user cannot easily estimate the remaining life of a battery or the necessary battery usage required for a particular activity, it is generally necessary to carry extra batteries. The necessity of carrying additional batteries is problematic for many reasons including inadvertent loss, battery damage, or improperly sized additional batteries.

Various existing technologies have been utilized to overcome this problem. One solution is to increase the number of batteries in the portable electrical device and electrically configure them in parallel to effectively increase the capacity of the batteries and therefore the usage time of a corresponding electrical device. Unfortunately, this solution unnecessarily increases the size and weight of the electrical device and still does not guarantee that a particular necessary amount of battery capacity will remain after numerous uses. Therefore, this solution does not effectively solve the problem.

A second solution involves the incorporation of a rechargeable battery or system into an electrical device. A recharging system allows a user to recharge or increase the capacity of a depleted battery so as to enable usage of the corresponding electric device. Unfortunately, in order to facilitate continuous usage of a portable electric device, this system requires that a user have immediate access to a recharging device or system. In many circumstances, portable electric device users may not be in the proximity of a recharging system, nor would they care to carry a recharging system in addition to their portable device. Therefore, this system also fails to overcome the problem.

A third solution involves carrying additional batteries associated with the particular portable electrical device. By carrying additional batteries, a user is guaranteed to have sufficient electrical storage to power the electrical device for the full capacity of the extra stored batteries. For example, if a user takes a portable flashlight camping that has previously been extensively used, the flashlight's batteries may only contain 10 minutes or less of battery power to sufficiently operate the flashlight. However, by bringing extra battery(s) and replacing the original batteries upon depletion, the user is able to utilize the flashlight for at least the capacity of the extra batteries. Therefore, bringing additional batteries overcomes the initial problem of capacity and unknown depletion.

The second problem associated with long-term portable electrical device usage is how to effectively store the extra batteries so as to prevent damage or inadvertent displacement. Batteries can be accidentally discharged or damaged if they are exposed to water, conductive materials, corrosive chemicals, etc. Batteries generally include a positive and negative terminal or region and are “shorted” if a conductive material contacts both terminals/regions simultaneously. Likewise, many battery form factors are extremely small and can easily be misplaced or lost. For example, commonly used coin cell or button cell batteries are shaped in the form a small circular disc.

Therefore, there is a need in the industry for an effective electrical storage system that overcomes both problems discussed above.

### SUMMARY OF THE INVENTION

The present invention relates to a protected and portable battery storage system and method of use. One embodiment relates a portable battery storage system, including a plurality of batteries and a plurality of sealed pouches. The batteries are shaped in a coin or disc configuration. The sealed pouches are interconnected to one another in a strip configuration. The batteries are positioned within a non-conductive internal region of each sealed pouch that protects them from damage and incidental short-circuiting. The non-conductive internal regions of the sealed pouches are sealed air-tight from the exterior via a lamination closure. The sealed pouches further include an individual opening system to allow a user to open a single sealed pouch for removal of the corresponding battery. One particular opening system includes a notch to facilitate hand-tearing of the sealed pouch. An alternative opening system includes utilizing a resealable opening system such as a ZIPLOC closure. A second embodiment of the present invention relates to dimensionally reducing a battery storage system by rolling or folding a plurality of sealed pouches coupled together in a strip configuration.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. In the Figures, the physical dimensions may be exaggerated for clarity. The same reference numerals in different drawings represent the same element, and thus their descriptions will be omitted.

FIG. 1 illustrates a perspective view of a battery storage system in accordance with one embodiment of the present invention;

FIGS. 2A-D illustrate a series of perspective views of a method of dimensionally reducing a battery storage system in accordance with a second embodiment of the present invention;

FIGS. 2E-G illustrate a series of perspective views of a method of opening a battery storage system in accordance with a third embodiment of the present invention; and

FIGS. 3A-D illustrate a series of perspective views of an alternative battery storage device that incorporates a resealable closure system.

### DETAILED DESCRIPTION OF THE INVENTION

The present invention relates to a protected and portable battery storage system and method of use. One embodiment relates a portable battery storage system, including a plurality of batteries and a plurality of sealed pouches. The batteries are shaped in a coin or disc configuration. The sealed pouches are interconnected to one another in a strip configuration. The batteries are positioned within a non-conductive internal region of each sealed pouch that protects them from damage and incidental short-circuiting. The non-conductive internal regions of the sealed pouches are sealed air-tight from the exterior via a lamination closure. The sealed pouches further include an individual opening system to allow a user to open a single sealed pouch for removal of the corresponding battery. One particular opening system includes a notch to facilitate hand-tearing of the sealed pouch. An alternative opening system includes utilizing a resealable opening system such as a ZIPLOC closure. A second embodiment of the present invention relates to dimensionally reducing a battery storage system by rolling or folding a plurality of sealed pouches coupled together in a strip configuration. While embodiments of the present invention are directed at battery storage systems and methods of use, it will be appreciated that the teachings of the present invention may also be applicable to other areas.

The following terms are defined as follows:

Battery—any electrical storage system configured to generate a particular voltage and current for a specific time. A battery may include any electrical capacity, physical shape, or packaging format including but not limited to coin cell, AA, AAA, etc.

Sealed pouch—a flexible multi-layer system that includes an internal region. For example, a retort pouch utilizes lamination to seal around the internal region. Various materials may be used to construct the pouch including but not limited to foils, plastics, etc.

Strip configuration—a plurality of items coupled to one another along a common axis. The common axis allows for the items to be joined on opposite sides. For example, a POSTIT™ pad of paper is a plurality of individual papers joined together in a strip wherein, the common axis is directed down through the center of the paper pad.

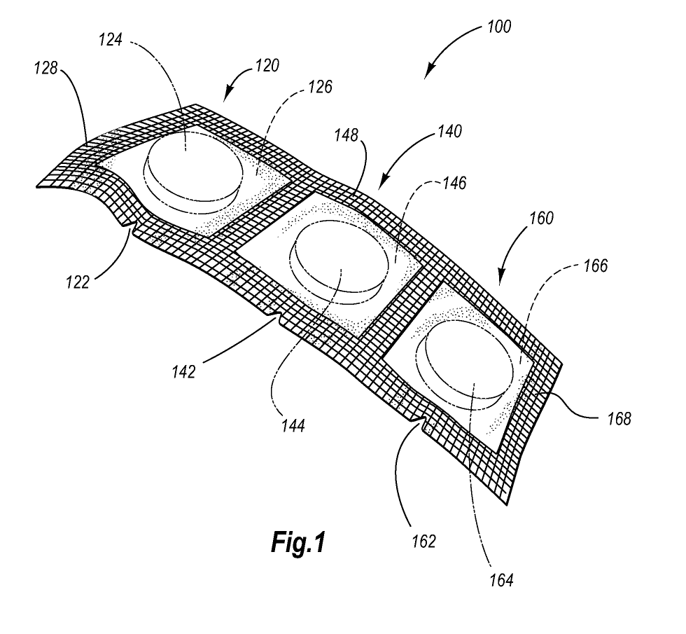

Reference is initially made to FIG. 1, which illustrates a perspective view of a battery storage system in accordance with one embodiment of the present invention, designated generally at 100. The system 100 includes three sealed pouches 120, 140, 160 coupled to one another in a strip configuration. The pouches 120, 140, 160 are coupled along a common axis so as to form a continuous strip. Any number of pouches may be coupled together and remain consistent with the present invention. The system further includes three batteries 124, 144, 164. The batteries are positioned within the sealed pouches 120, 140, 160 as illustrated. The illustrated batteries 124, 144, 164 are coin cell batteries configured in which the positive terminal is disposed on one flat side and the negative terminal is disposed on the opposite flat side. Various battery sizes, shapes, packaging, capacities, etc may be utilized in conjunction with the system 100.

The pouches 120, 140, 160 further include a seal 128, 148, 168, an internal region 126, 146, 166, and an opening system 122, 142, 162. The internal region 126, 146, 166 is a three dimensional region in which the batteries 124, 144, 164 are correspondingly disposed. The internal region 126, 146, 166 is three dimensionally sealed by the seal 128, 148, 168. The internal region 126, 146, 166 is surrounded by a non-conductive material so as to prevent inadvertent short circuiting of the enclosed batteries 124, 144, 164. The seal 128, 148, 168 includes a multi-layer flexible material positioned above and below the batteries 124, 144, 164. The seal 128, 148, 168 further includes bonded regions in which the multi-layer flexible material is bonded to itself, thereby individually sealing the internal regions 126, 146, 166. The bonded regions may also be referred to as laminated regions in that lamination may be used to bond the layers of the multi-layer flexible material in the pattern illustrated. The illustrated combination of a single one of the internal region 126 and seal 128 is commonly referred to as a retort pouch.

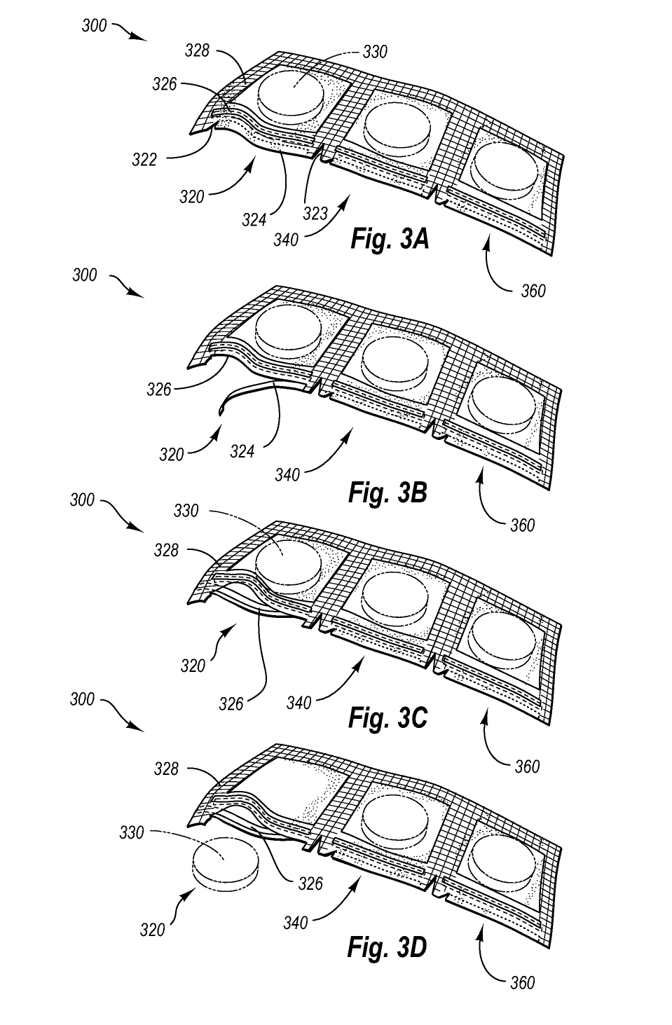

The opening systems 122, 142, 162 refer to a system that allows a user to open or expose the internal region 126, 146, 166 and the batteries 124, 144, 164. An individual opening system is necessary to enable a user to individually remove the batteries 124, 144, 164 from the remainder of the system 100. The illustrated opening system 122, 142, 162 is a slit or notch that allows a user to permanently hand-tear open or expose the internal region 126, 146, 166. The illustrated slits create a tactile weakness in the multi-layer flexible material of the seal 128, 148, 168 which allows for a user to tear open the internal region 126, 146, 166 by applying opposite forces. Various alternative opening systems may also be utilized in conjunction with the system 100 including but not limited to the releasable opening system illustrated in FIGS. 3A-3D.

In operation, a user may remove the battery 124 from the first pouch 120 by performing particular acts. If the system 100 is rolled up or compressed in any way, the user must initially flatten out and/or expose the first pouch 120. The user must then grasp opposite sides of the slit. For example, a user may utilize an index finger and thumb of each hand to grasp the opposite sides. The user then exerts outward opposing forces on the slit. For example, the user may direct the left portion up and the right portion down, thereby exerting a ripping force on the seal 128 of the pouch 120. The ripping force can be continued so as to sufficiently expose the battery 124 for removal. The user may not wish to continue the ripping force beyond the internal region 126 so as to maintain a coupling between the two portions of the pouch 120.

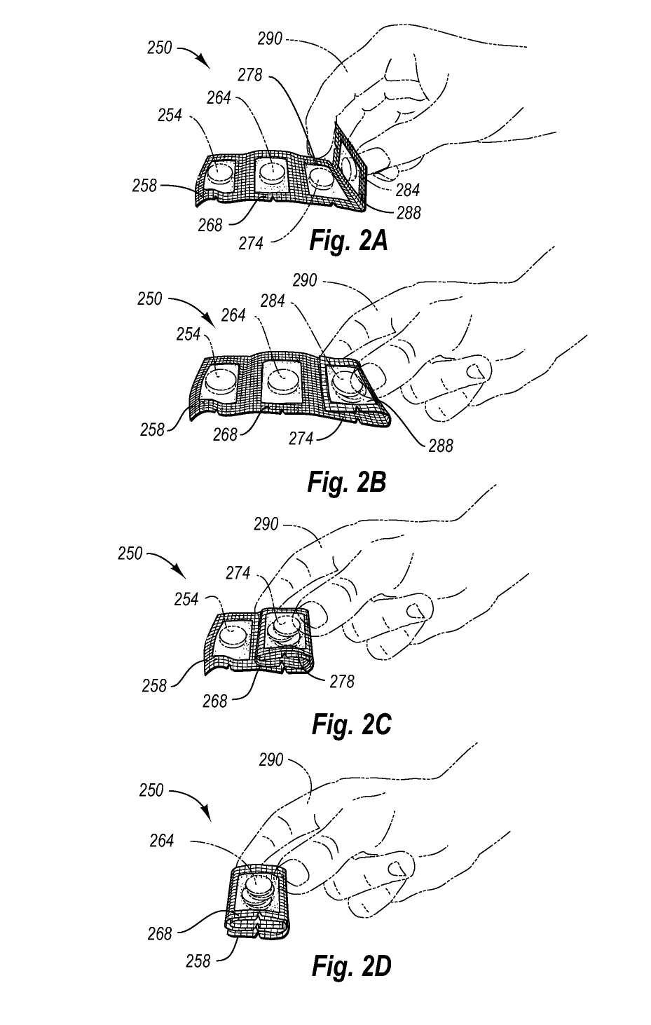

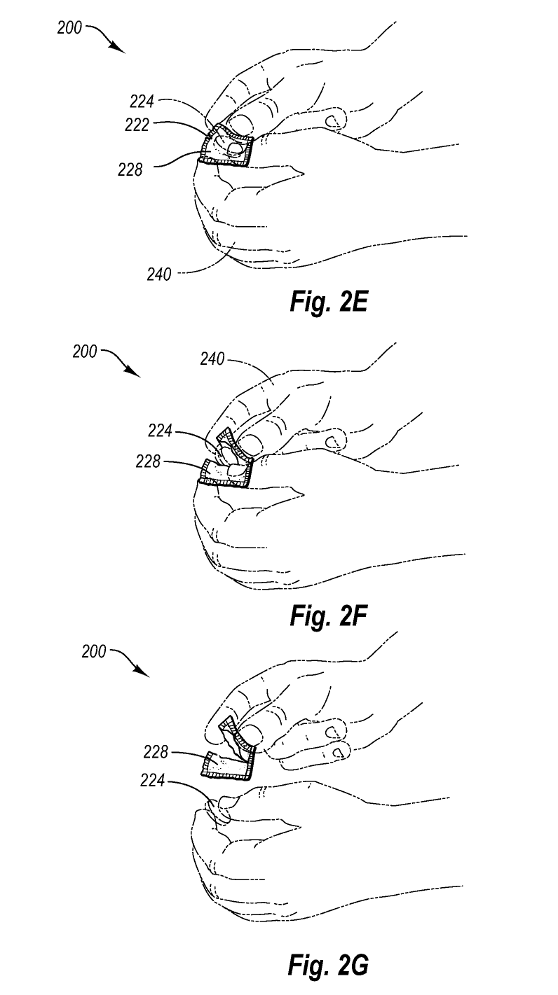

Reference is next made to FIGS. 2A-2D, which illustrate a series of perspective views illustrating a method of dimensionally reducing a battery storage system in accordance with a second embodiment of the present invention, designated generally at 250. The illustrated battery storage system includes four pouches 258, 268, 278, 288, and four batteries 254, 265, 274, 284. In addition, a user's hand is designated at 290. One of the important features of embodiments of the present invention is the utilization of flexible materials to facilitate various dimensional reduction schemes. The illustrated embodiment is merely one method of dimensionally reducing a battery storage system in accordance with the present invention. Initially, FIG. 2A illustrates folding and/or rolling a first portion of the strip of interconnected pouches. The first portion is a particular region next to one end of the strip of pouches. An end of the strip of pouches is defined as one of the two short two-dimensional sides of the strip of interconnected pouches. The first portion is rolled and/or folded toward the opposite end of the strip of interconnected pouches. In the illustrated embodiment, the first portion is essentially the entire fourth pouch 284 and the opposite end is the illustrated left side of the first pouch 258. The degree of rolling/folding depends on the size of the battery and the desired final dimensions. For example, a tight roll will enable the smallest dimensional reduction of the battery storage system. Next, FIG. 2B illustrates overlapping the fourth pouch 288 and battery 284 on top of the third pouch 278 and battery 274 so as to join the first end to an internal portion of the strip. FIG. 2C illustrates repeating the rolling and/or folding process with the overlapped region of the third and fourth pouches 274, 284 created in FIGS. 2A-2B so as to overlap the second, third and fourth pouches 264, 274, 284. FIG. 2D illustrates further continuing to roll and/or fold so as to completely overlap the entire system upon itself, thereby overlapping all four pouches 284, 274, 264, 254. Various numbers of rolls/folds may be necessary depending on the number of pouches and the tightness of the rolling/folding.

Reference is next made to FIGS. 2E-2G, which illustrate a series of perspective views illustrating a method of opening a battery storage system in accordance with a third embodiment of the present invention, designated generally at 200. The illustrated battery storage system only includes a single pouch 228, battery 224, and opening system 222. A user's hands are designated at 240. In order to clearly illustrate the opening system, additional pouches have been removed. However, it will be appreciated that a similar process may be used for battery storage systems that include multiple pouches. FIG. 2E illustrates a user grasping opposite sides of the slit portion of the opening system 222. The illustrated slit is disposed in substantially the middle of one side of the pouch 228. FIG. 2F then illustrates the user exerting opposite forces on either side of the slit so as to tear open the pouch 228 and expose the battery 224. FIG. 2G then illustrates the removal of the battery 224 from the pouch 228.

Reference is next made to FIGS. 3A-3D, which illustrate a series of perspective views of an alternative battery storage device that incorporates a resealable closure system, designated generally at 300. The illustrated battery storage device 300 includes three pouches 320, 340, and 360. The first pouch 320 further includes a seal 328, a battery 330, and an opening system. The opening system on the first pouch includes a start notch 322, a tab 324, a stop notch 323, and a resealable opening 326. The seal 328 forms an air-tight seal around an internal region in which the battery 328 is disposed. The opening system allows a user to open a single pouch, remove the battery for use, and then replace the battery when it has been discharged. The start notch 322 enables the removal of the tab 324, thereby exposing the resealable opening 326. The start notch 322 is configured to allow a user to hand-tear off the tab with a sufficient tearing force generated by opposing outward forces. The stop notch 323 prevents the tearing from continuing past the first pouch 320. FIG. 3B illustrates the tab 325 being torn away from the pouch 320 so as to expose the resealable opening 326. The tab 325 also protects the resealable opening 326 from inadvertently being opened before a user is ready to utilize the corresponding battery 330. In addition, the disposition of the tab 325 may also be used to quickly identify whether a particular pouch 320 and corresponding battery 330 have been used.

FIG. 3C illustrates opening of the resealable opening 326 so as to expose the battery 330 and facilitate removal. The illustrated resealable opening 326 is an oppositely grooved system, commonly referred to as a ZIPLOC™. Various other resealable opening systems may also be incorporated in accordance with the present invention. The resealable opening 326 may be opened by physically separating the illustrated top and bottom layers or by exerting opposite inward forces. FIG. 3D illustrates the battery 330 removed from the pouch 320 via the resealable opening 326. The resealable opening 326 may be resealed to prevent debris from entering the first pouch 320. Since the tab 324 is removed from the first pouch, it is clear that the battery 330 corresponding to the first pouch 320 has either been removed or used. Once the battery 330 is depleted, the first pouch 320 may also be used for storage and disposal by simply reopening the resealable opening 326, positioning the battery 330 back inside the pouch 330, and resealing the resealable opening 326.

Various other embodiments have been contemplated, including combinations in whole or in part of the embodiments described above.

What is claimed is:

1. A portable electrical storage system comprising:
at least one electrical storage device configured to transmit a particular electrical current and voltage, wherein the at least one electrical storage device includes a positive terminal and a negative terminal; and
at least one sealed pouch including a non-conductive internal region and a seal, wherein each of the at least one sealed pouches are interconnected in a strip configuration, and wherein each of the at least one sealed pouches individually enclose one of the at least one electrical storage devices within the non-conductive internal region, and wherein the seals forms an air-tight seal around the respective non-conductive internal region, and wherein each of the at least one sealed pouches include an individual opening system.

2. The system of claim 1, wherein the at least one sealed pouch is a retort pouch.

3. The system of claim 1, wherein the seals include lamination lines oriented such that they form the air-tight seal around the non-conductive internal region.

4. The system of claim 1, wherein the at least one electrical storage devices are batteries.

5. The system of claim 1, wherein the at least one sealed pouches are flexible such that they can be rolled and folded around the at least one electrical storage devices enclosed within.

6. The system of claim 1, wherein the individual opening system includes a slit that allows for hand tearing of the corresponding sealed pouch.

7. The system of claim 1, wherein the individual opening system includes a resealable opening.

8. The system of claim 7, wherein the resealable opening further includes:
an opening to the internal non-conductive region;
a tear off strip covering the opening; and
a resealable system disposed between the tear off strip and the opening.

9. The system of claim 7, wherein the resealable system is a ZIPLOC strip that covers the opening.

10. The system of claim 1, wherein the strip configuration includes laterally coupling the at least one sealed pouches to one another along a single axis.

11. The system of claim 1, wherein the at least one sealed pouches are composed of at least two materials of different insulating properties.

12. A portable battery storage system comprising:
a plurality of electrical storage devices configured to transmit a particular electrical current and voltage, wherein the at least one electrical storage device includes a positive terminal and a negative terminal; and
a plurality of sealed pouches each including a non-conductive internal region and a seal, wherein the plurality of sealed pouches are interconnected in a strip configuration, and wherein the sealed pouches individually enclose one of the plurality of electrical storage devices within the non-conductive internal region, and wherein the seals of the sealed pouches form an air-tight seal around the respective non-conductive internal region, and wherein each of the sealed pouches include an individual opening system.

13. The system of claim 12, wherein the seals include lamination lines oriented such that they form the air-tight seal around the non-conductive internal region.

14. The system of claim 12, wherein the strip configuration includes laterally coupling the at least one sealed pouches to one another along a single axis.

15. The system of claim 12, wherein the at least one sealed pouches are composed of at least two materials of different insulating properties.

16. A method for dimensionally reducing a plurality of sealed electrical storage devices comprising the acts of:
providing a plurality of electrical storage devices independently sealed in an interconnected strip of flexible non-conductive pouches;
folding an end of the interconnected strip of flexible non-conductive pouches toward the opposite end; and
continuing to fold the interconnected strip of flexible non-conductive pouches over the opposite end such that the entire interconnected strip of flexible non-conductive pouches is reduced to a folded configuration.

17. The method of claim 16, wherein the electrical storage devices are batteries and the non-conductive flexible pouches are retort pouches.

18. The method of claim 16, wherein the act of folding an end of the interconnected strip of flexible non-conductive pouches toward the opposite end further includes:
grasping the end of the interconnected strip of flexible non-conductive pouches; and
folding the end of the interconnected strip of flexible non-conductive pouches toward an opposite end.

19. The method of claim 16, wherein the act of continuing to fold the interconnected strip of flexible non-conductive pouches over the opposite end such that the entire interconnected strip of flexible non-conductive pouches is reduced to a folded configuration further includes folding an overlapped folded region of the interconnected strip of flexible non-conductive pouches.
